(19) United States
(12) Patent Application Publication
(10) Pub. No.: US 2010/0166515 A1
(43) Pub. Date: Jul. 1, 2010

(54) Deburring Tool For Deburring Drilled Holes With Paired Assembly Of Cutting Knives And A Rotary-Driven Tool Holder

(75) Inventors: Heinrich Heule, Au (CH); Gary Brown, Loveland, OH (US)

Correspondence Address: WOOD, HERRON & EVANS, LLP, 2700 CAREW TOWER, 441 VINE STREET, CINCINNATI, OH, 45202, US

(73) Assignee: Ulf Heule, Balgach (CH)

(21) Appl. No.: 12/554,302

(22) Filed: Sep. 4, 2009

(30) Foreign Application Priority Data
Sep. 8, 2008 (DE) 10 2008 046 087.7

(51) Int. Cl. B23B 51/00

(52) U.S. Cl. 408/186

(57) ABSTRACT

Deburring tool for deburring holes with a dual cutting knife assembly and a rotary-driven tool holder, in which, in a knife recess in the rotary-driven tool holder, the opposing cutting knives' cutting edges point radially outward by means of a rocker swivel located inside the tool holder that is mounted and flexibly prestressed in an axial direction around an axial longitudinal axis, pressed outward by pins frontally located on the rocker swivel, by which the pins correspondingly engage in a groove in the cutting element, characterized by the fact that the rocker swivel is placed against the force of a spring that simultaneously acts as a torsion spring, and located in the knife housing of the deburring tool and can be raised and lowered.

The invention relates to a deburring tool according to the so-called GH-S principle as best described in EP 0 291 563 B1. Reference will be made to the content of revelation there, and this content of revelation should be fully encompassed by the content of revelation of this application.

Thus the invention proceeds from the aforementioned document and involves a tool for deburring drilled holes with a paired assembly of cutting knives, whereby the cutting knives are located opposite conical cutting edges that point radially outward in a rotary-driven tool holder in a rectangular receiving slot (knife recess).

The cutting knives are pressed outward by a rocker swivel that is located inside the tool holder and is flexibly prestressed by means of pins frontally located on the rocker swivel, whereby the pins each engage into a groove of the cutting element.

According to the state of the art, the rocker is only flexibly prestressed in the direction of rotation, i.e., there is only a torsion spring in place. However, no axial spring preload of the rocker swivel is provided.

To be able to exchange a pair of cutting knives, it is conventional in the state of the art according to EP 0 291 563 B1 to raise the rocker swivel by means of an eccentric tappet, set laterally in the direction of the longitudinal axis, in order to bring the rocker studs located on the face of the rocker swivel out of engagement with the associated recesses in the corresponding cutting knife. However, remounting of such cutting knives poses great problems. For this one has to bring back the eccentric tappet used to raise the rocker swivel by gradually rotating the eccentric tappet downward, again in the direction of the knife recess, and at the same time try, with the rocker stud located on the free face of the rocker, to meet the corresponding bolt groove located on the upper edge of the cutting knife. This process had to be implemented for both knives simultaneously, i.e., while the rocker swivel was lowered, the rocker stud as well as the bolt groove in one cutting knife and the bolt groove in the other cutting knife had to meet simultaneously, so that both cutting knives could be anchored.

This happened under constant pressure and lowering with the help of the eccentric screw, which directed the raising and lowering of the rocker swivel, however while no view of the rocker studs' assembly was possible as they traveled into the bolt grooves in the cutting knives.

Thus the entire remounting had to be done blindly and without further mechanical assistance. It goes without saying that such a remounting is difficult and proportionately time-consuming. There was also the danger that the rocker studs were unintentionally damaged or the bolt groove in the cutting knife was deflected, giving the knives impermissible play.

With the object of EP 0 850 119 B1, easier replacement of the knives is possible in another deburring tool with a different drive principle. The drive principle of the aforementioned EP 0 850 119 B1 is based on the fact that a bolt that is flexibly prestressed in the axial direction engages with its lower face in a control recess on the upper side of just one knife.

Therefore, all that is needed to replace or remount the cutting knife is to press the cutting knife into the knife recess with a lead-in chamfer, by which the lead-in chamfer comes onto the side of the flexibly mounted bolt, which is thereby pressed upward and then automatically snaps into the knife recess.

Thus easy replacement of an individual cutting knife indeed became known in principle, however it is not possible to transfer this principle to a rigid rocker according to EP 0 291 563 B1. According to the subject of that document, the rocker itself is not flexibly prestressed in the axial direction and the rocker studs are therefore rigid and therefore not liftable against spring force, but only under the influence of the eccentric tappet described above.

The task of the invention is therefore to further configure a deburring tool of the type described at the beginning, such that considerably simpler replacement of the cutting knives is possible in connection with guided spring prestressing of the knives.

As a solution to the problem posed, the invention of the technical theory for claim 1 is characterized.

A significant characteristic of the invention is that a force from a pressure spring that simultaneously operates as a torsion spring raises and lowers against the rocker swivel in the knife housing of the deburring tool and that the spring preload in the torsional direction can be adjustably controlled.

Within the given technical teaching there is the considerable advantage that now, instead of a rigid rocker that is only adjustable with an eccentric tappet—as described in EP 0 291 563 B1—instead a flexibly prestressed rocker swivel is provided that under spring preload presses the rocker stud into the associated bolt groove of the corresponding cutting knife.

Thus is described for the first time simple replacement for a GH-S deburring knife, which could not be deduced from EP 0 291 563 B1.

The axially flexible form of the rocker swivel provides for the first time the possibility—as known from EP 0 291 563 B1—of raising the rocker swivel using an eccentric tappet against the force of the screw pressure spring and thus bringing the rocker stud out of engagement with the bolt grooves in the corresponding cutting knives. In this way, the cutting knives can easily be pulled out of the knife recess.

For remounting the eccentric tappet is adjusted such that it arrives in the rocker's release area and the screw pressure spring exerts spring force only on the rocker swivel, so that the latter can be freely shifted in an axial direction in the knife housing and mounted by the action of the screw pressure spring.

Now when a cutting knife is slid into the knife recess, then a lead-in chamfer according to the invention located on the cutting knife meets the now flexibly formed rocker stud, pushes the latter together with the rocker swivel attached to it in an axial direction backwards against the spring force, and the cutting knife is slid into the knife recess while the rocker stud automatically engages into the bolt groove on the cutting knife. It therefore no longer requires an actuator of an eccentric tappet or similar component, but the insertion and securing of the cutting knife for remounting purposes is automatic.

This a considerable advantage over the current state of the art. Up to now it has not been possible to change the cutting knives on a rocker-driven deburring tool easily.

Another important characteristic of the present invention is the simplified tensioner system, which is achieved with the screw pressure spring and simultaneously also a torsion spring, and the torsion preload of this screw pressure spring can be sensitively adjusted. For this purpose, a tensioning element is included, which allows the torsion spring to be adjusted to a definite value. For this purpose it is provided that the tensioning element mainly consists of several sleeve parts that are rotatable and located in the upper portion of the base body of the deburring tool, at which this tensioning element can be secured with a stop screw. This means that, with the help of a hand-twistable clamping chuck, the tensioning element can be freely turned, even in the area of several index holes equally distributed around the circumference, and once the desired spring pretension has been achieved, which can be freely adjusted, the up-and-down adjustable tensioning element is shifted back into the base body and fixed, so that a one-time setting of the torsion prestress on the spring remains consistent and upright.

This allows sensitive setting of the spring's torsion prestress, which has not been the case with the state of the art up to now.

This makes, for the first time, reproducible setting of the spring's torsion prestress, which has not been the case with the state of the art up to now.

As a rotation setting for the tensioning element, the state of the art allowed only a tensioning screw that worked with a worm shaft, which turned the tensioning element. This allowed no reproducible setting for the spring pretension. The pretensioning screw has been eliminated in conjunction with the originally included tensioner.

In addition, with the present invention, handling is significantly easier, because on the one hand the tensioning element can now be set to reproducible presets, and on the other hand because replacing knives is especially easy.

The object of this invention arises not only from the object of the individual patent claims, but also from the combination of the individual patent claims together.

All of the documentation, including the summary of disclosed data and characteristics, especially the spatial design depicted in the drawings, are claimed to have significance as inventions, as long as they are new individually or in combination in relation to the state of the art.

Below, the invention will be explained in more detail by means of several drawings that depict only one manner of execution. In connection with this, further significant characteristics and advantages significant to the invention arise from the drawings and their descriptions.

Depicted are:

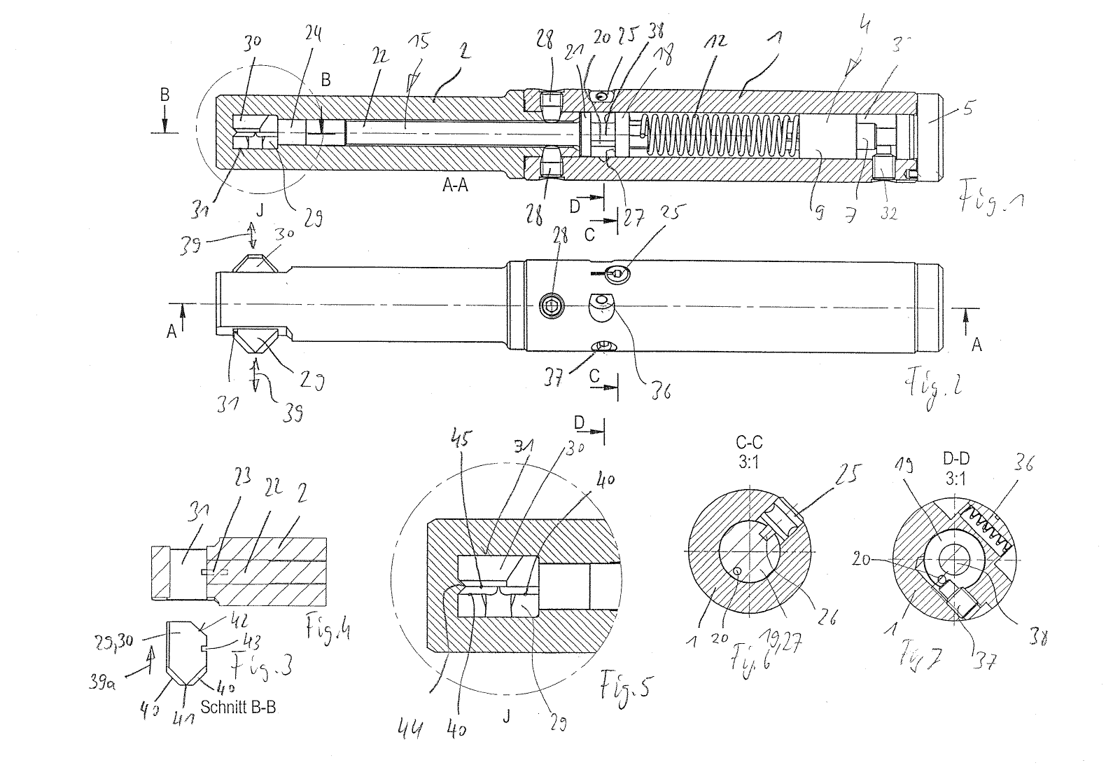

FIG. 1: A longitudinal section of a deburring tool according to the invention in the direction of line A-A in FIG. 2.

FIG. 2: A lateral view of the deburring tool at a 90° rotation in comparison to FIG. 1.

FIG. 3: Lateral view of a cutting knife.

FIG. 4: A section according to line B-B in FIG. 1.

FIG. 5: Depiction of detail J in FIG. 1.

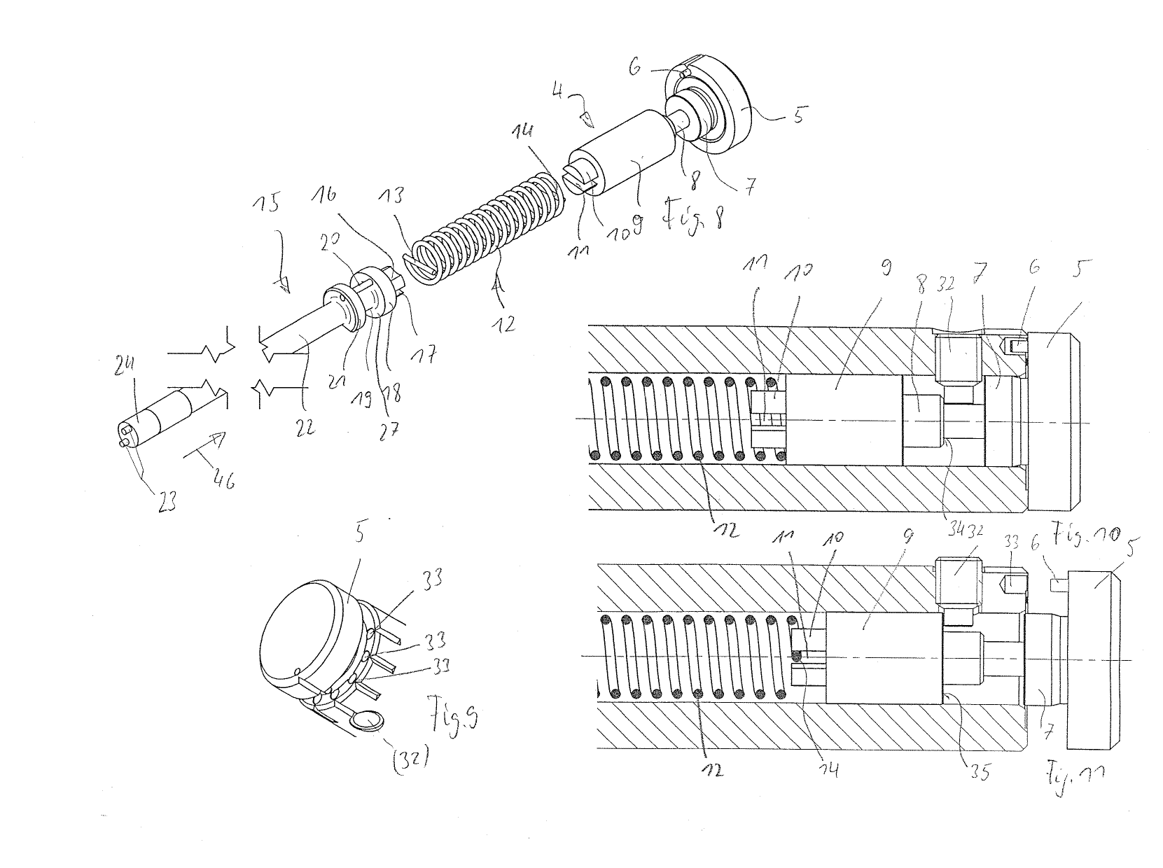

FIG. 6: A section according to line C-C in FIG. 2.

FIG. 7: A section according to line D-D in FIG. 2.

FIG. 8: An exploded view of the deburring knife's internal structure.

FIG. 9: A perspective view of the clamping chuck in relation to the fixed marks on the base body for rotational setting of the tensioning element.

FIG. 10: A section of the upper part of the deburring knife's base body with engaged tensioning element.

FIG. 11: The same section as in FIG. 10 with the tensioning element disengaged.

The base body 1 according to FIGS. 1 and 2 is largely a cylindrical metal housing that is open in front and in back.

In the front area of the base body 1, the knife housing 2 is plugged or screwed in; the latter consists of a tubular metal body. The base body displays a continuous central hole 3 that extends to the knife housing 2. At that location there is also a continuous central hole that is aligned with the aforementioned central hole.

It is within the framework of the present invention to form the base body 1 and the knife housing 2 from a single continuous piece.

At the rear area of the base body 1, a tensioning element 4 is located, which largely consists of an outer hand-turnable clamping chuck, which according to FIG. 8 has a torque-proof connection to a tubular part 7, which in turn has a torque-proof connection to a shaft of a smaller diameter 8, which itself is connected to a guide hub 9 of a larger diameter. In this way the tensioning element 4 is rotatably mounted without play into the central hole 3 of base body 1.

On the inner face of the clamping chuck 5 there is an index bolt 6 located, opposite which a row of index holes 33 are located on the upper face of the base body, as can be seen best in FIGS. 9, 10 and 11.

On the lower end of the guide hub 9 there is a slot 10 that forms a central receiving slot 11. Into this central receiving slot 11, goes a bent-off contact tongue 14 of a spring 12 whose the opposite face displays an identically bent-off contact tongue 13, which in the same manner goes into a receiving slot 17 of a slot part 16, onto which a rocker swivel 15 is attached.

Here it should be noted that for the spring 12 any type of spring can be installed, preferentially a coil spring; the use of a coil spring is claimed as significant to the invention.

The rocker swivel 15 consists of a continuous piece, on which on the slot part 16 a guide hub 18 is attached, which itself gives way to a free area 19, which a bolt 20 bridges over, at which a connecting axis 38 is located. Thus, according to FIG. 1, the bolt 20 is located in a specific radial gap from the connecting axis 38, in regard to which it can be seen from FIG. 7 that an adjusting screw is attached at its bolt end to the bolt 20, and its circumferential rotation, which is brought about by the spring 12, is limited. It is therefore a rotation stop for the rocker swivel 15. This makes certain that the cutting knives 29, 30 located opposite one another can be set in their opposing diameters. In this way a debarring radius can be set.

On the other side of the free area 19 and the bolt 20, the rocker swivel 15 goes into a guide hub 21 that serves as a swivel for the rocker swivel 15 in the base body 1. There a rocker neck 22 of a smaller diameter is joined, which is rotatably mounded in the central hole of the knife housing 2, on whose free front end a guide bore is molded, which provides the play-free mount for the rocker neck 22 in the central hole of the knife housing 2.

On the front face of the guide bore 24 are two rocker studs 23 that are located opposite one another in a gap, as can be seen best in FIG. 8.

When passing through a drilled hole, the cutting knives 29, 30 meet the edge of the drilled hole and are pressed back against the force of the spring 12 in the knife recess 31, whereby during this process the front cutting edge 40 according to FIG. 3 of the corresponding cutting knife 29, 30 comes into contact with the edge of the drilled hole and deburrs it.

As soon as the cutting knives 29, 30 come into the interior diameter of the drilled hole, the floating radius 41 comes to rest on the interior circumference of the drilled hole, and the knives are led into the knife recess 31 against the force of the spring 12 through rotation of the rocker swivel.

After moving through the drilled hole, the cutting knives 29, 30 can also deburr the rear edge of the drilled hole, because the opposingly located cutting edges 40 come into contact with this rear edge of the drilled hole.

Adjustment of the knives 29, 30 during the cutting process and while moving through the drilled hole thus occurs also in the arrow directions 39 per FIG. 2.

In regard to this, it should also be noted that with setting of the adjusting screw 37 bevel diameter can also be set, because with it the maximum diameter of the cutting knives 29, 30 can also be set in the arrow directions 39.

According to FIG. 6, an eccentric tappet 25 is in place, which comes into contact with an eccentric bolt 26 in the free area 19, by which the eccentric bolt 26 contacts the abutting face 27 of the guide hub 18. If the eccentric tappet 25 is twisted, then the eccentric bolt 26 is turned against the abutting face 27 and thus raises the whole rocker swivel 15 in the direction of the arrow 46 (see FIG. 8), such that the rocker stud 23 comes out of contact with the bolt groove 43 of the corresponding cutting knife 29, 30. In this way, the cutting knives 29, 30 fall automatically, so to speak, out of the knife recess 31.

If the eccentric tappet 25 is adjusted again in the opposite direction, then the eccentric bolt 26 comes out of contact with the abutting face 27 of the guide hub 18 and is free of it.

In this way the rocker swivel 15 can freely move in the direction of the arrow 46 and in the opposite direction in the knife housing against the force of the spring 12, so that after that only a spring pretension of the rocker stud 23 onto the cutting knives 29, 30 in the area of the bolt grooves 43 occurs.

Now, in this way a removed cutting knife 29, 30 can be easily installed again. For this, only the eccentric tappet 25 has to be disengaged, so that the eccentric bolt 26 comes free of the abutting face 27 and the rocker swivel is now only freely movable under the stress of the spring 12, adjustably in the direction of the arrow and in the opposite direction in the knife housing 2. Now it is easy to slide the corresponding cutting knife 29, 30 in the direction of the arrow 39a into the knife recess 31, whereby the rocker stud 23 according to FIG. 4 is slid back in the direction of the arrow 46 against the force of the spring 12 and then as the cutting knife 29, 30 is further slid in, the rocker stud 23 comes automatically into contact with the bolt groove 43 of the cutting knife 29, 30.

To ensure a better, tilt-free insertion of the corresponding cutting knife 29, 30 into the knife recess 31, on the base of the knife recess 31 a conical, inward-projecting guide bar 44 is provided that extends into the knife recess and which is faced by an associated conical, guide recess in the corresponding cutting knife 29, 30. Thus the cutting knives are held movably and tilt free on the corresponding guide bar 44. Because each cutting knife 29, 30 is associated with such a guide bar 44, such tilt-free insertion of each cutting knife 29, 30 into the knife recess 31 is achieved, and it is thus ensured that the rocker stud 23 always arrives centrally into the bolt groove 43 of the corresponding cutting knife 29, 30 and there snaps in.

Both cutting knives 29, 30 touch each other in the area of a central, vertical parting plane 45 and are radially adjustable against one another there.

With the help of two opposing locking screws that are screwed into associated threaded holes in the base body 1, the knife housing 2 is held under tension in the central hole 3 of the base body 1.

FIGS. 8 to 11 clarify the special function of the spring pretension in more detail.

As already explained, the tensioning element 4 consists of a clamping chuck 5, and with the help of a stop screw 32 radially screwed into the upper part of the base body it is ensured according to FIG. 10 that the tensioning element 4 cannot move backwards in the direction of the arrow 46, because the stop screw 32 lies against an abutting face 34 of the shaft 8.

In the position according to FIG. 11, on the other hand, the tensioning element 4 can be actuated by hand, while the clamping chuck 5 is freely twisted, whereby the spring 12 is wound in the direction of rotation, so to speak. By correspondingly bringing the index bolt 6 out of engagement with the associated index hole 33, according to FIG. 9 the rotational position of the tensioning element 4 to the base body 1 can be set.

The abutting face 35 at the rear face of the guide hub 9 prevents the entire tensioning element 4 from falling out backwards in the direction of the arrow 46.

The fixing bolt 36 according to FIG. 2 holds the eccentric tappet 25 in its rotational position, so that it cannot fall out in an axial direction.

An advantage of the deburring knife described above is consequently easy operability, the formation of the rocker swivel as a spring element, which is formed to be flexible in an axial direction, so that the cutting knives 29, 30 can be installed in the knife recess 31 in an especially simple manner.

A further advantage is the special tensioner system with the tensioning element 4 that allows the spring's torsion prestress to be set repeatedly. This a considerable advantage over the current state of the art, because in the current state of the art there was no double function for a spring that works as both a screw pressure spring and as a torsion spring. This is achieved with the spring 12 described here.

The fact that the pretensioning of the spring 12 is repeatable is especially important, because the deburring action and cutting action of the cutting knives 29, 30 over the cutting edge 40 are only achieved through the prestressed force of the spring 12 in the torsional direction. The spring force therefore immediately corresponds to the bevel size of the edge of the drilled hole to be deburred.

### KEY TO DRAWINGS

1. base body
2. knife housing
3. central hole
4. tensioning element
5. clamping chuck
6. index bolt
7. tubular part
8. shaft
9. guide hub
10. slot piece
11. receiving slot
12. spring
13. contact tongue
14. contact tongue
15. rocker swivel
16. slot piece
17. receiving slot
18. guide hub
19. free area
20. bolt
21. guide hub
22. rocker neck
23. rocker stud
24. guide bore
25. eccentric tappet
26. eccentric bolt
27. abutting face
28. locking screw
29. cutting knife
30. cutting knife
31. knife recess
32. stop screw
33. index hole
34. abutting face
35. abutting face
36. fixing bolt
37. locking screw
38. connecting axis
39. arrow direction a
40. cutting edge
41. floating radius
42. lead-in chamfer
43. bolt groove
44. guide component
45. parting plane
46. direction of arrow

1. Deburring tool for deburring holes with a dual cutting knife assembly and a rotary-driven tool holder, in which the cutting knives lie opposite each other in a knife recess with cutting edges pointing radially outward through a rocker swivel located inside the tool holder, which rocker swivel is rotatably mounted around an axial longitudinal axis and is flexibly prestressed in an axial direction by means of rocker studs that are frontally located on the rocker swivel and are radially and adjustably driven against one another, each rocker stud of the rocker swivel engaging into a groove in the cutting element, characterized by the fact that the rocker swivel (15) can be raised and lowered against the force of a spring (12) located in the knife housing (2) of the deburring tool.

2. Deburring tool according to claim 1, characterized by the fact that, under axial pretension of the spring (12), the flexibly prestressed rocker swivel (15) presses the rocker stud (23) into the associated bolt groove (43) of the corresponding cutting knife (29, 30).

3. Deburring tool according to claim 1 or 2, characterized by the fact that, by means of an eccentric tappet (25), the rocker swivel (15) can be raised against the force of the spring (12) and thereby brings the rocker stud (23) out of engagement with the bolt groove (43) of the corresponding cutting knife (29, 30).

4. Deburring tool according to claims 1 to 3 characterized by the fact that, for remounting of the cutting knives the eccentric tappet (25) is adjustable such that it arrives in a free area (19) of the rocker swivel (15) and then only exerts the force of the pressure spring onto the rocker swivel (15), so that this knife housing (2), which is freely adjustable in an axial direction, is mounted under the effect of the pressure spring.

5. Deburring tool according to one of the claims 1 to 4, characterized by the fact that in the rear area of the base body (1) a tensioning element (4) is located, which consists of a hand-rotatable clamping chuck (5), which is connected torque-proof to one end of the spring (12).

6. Deburring tool according to one of the claims 1 to 5, characterized by the fact that the other end of the spring (12) is connected torque-proof to the rocker swivel (15).

7. Deburring tool according to one of the claims 1 to 6, characterized by the fact that for slant-free insertion of the corresponding cutting knife (29, 30) at the base of the knife recess (31) of the knife housing, a conical, inward-projecting guide bar (44) is provided, which is faced by an associated conical, guide recess in the corresponding cutting knife 29, 30.

8. Deburring tool according to one of the claims 1 to 7, characterized by the fact that the debarring and cutting action of the cutting knives, brought about by the cutting edges (40), are achieved only through the force of the spring (12) in the torsional direction and is prestressed outward in a radial direction.
